(19) United States
(12) Patent Application Publication
(10) Pub. No.: US 2026/0245408 A1
(43) Pub. Date: Aug. 20, 2026

(54) REGION-AWARE DYNAMICS MODELING FOR VIDEO DEEPFAKE DETECTION

(71) Applicant: Reality Defender, Inc., New York, NY (US)

(72) Inventors: Gaurav BHARAJ, Los Angeles, CA (US); Divyarajsinhji Jayvantsinh SOLANKI, Brookline, MA (US); Nicolò BONETTINI, Sassuolo (IT)

(73) Assignee: Reality Defender, Inc., New York, NY (US)

(21) Appl. No.: 19/542,140

(22) Filed: Feb. 17, 2026

Related U.S. Application Data
(60) Provisional application No. 63/760,027, filed on Feb. 18, 2025.

(51) Int. Cl. G06V 40/40; G06V 10/26; G06V 10/75; G06V 10/764; G06V 10/774; G06V 40/16

(52) U.S. Cl. CPC G06V 40/40; G06V 10/267; G06V 10/751; G06V 10/764; G06V 10/774; G06V 40/171

(57) ABSTRACT

A method for detecting deepfake images in a video, the method comprising: receiving time-series image data from the video; inputting the time-series image data into an encoder module of a machine learning model to generate one or more embeddings; inputting the one or more embeddings into a classifier module of the machine learning model, wherein the classifier module is trained to generate a classification result classifying the time-series image data as real or fake using the plurality of image embeddings; and outputting the classification result from the classifier classifying the time-series image data from the video as real or fake.

### CROSS REFERENCE TO RELATED APPLICATIONS

This application claims the benefit of U.S. Provisional Application No. 63/760,027, filed Feb. 18, 2025, the entire contents of which is incorporated herein by reference.

### FIELD

This disclosure relates generally to deepfake video detection and more specifically to deepfake detection methods that consider temporal dynamics and focus on difficult-to-generate facial regions.

### BACKGROUND

With advancements in generative artificial intelligence models, it has become relatively easy to change one's expressions and appearance using machine learning, even without extensive prior knowledge of the technology. While such “deepfake” generation machine learning models can be used for benign purposes, malicious use cases abound, including fraud and misinformation. Such malicious use cases lead to privacy concerns and undermine the reputation and trust of the person being “deepfaked.” Alongside growing generative content technologies, researchers are actively working on robust deepfake detectors to combat the mentioned risks. However, existing deepfake detection techniques fail to adequately consider temporal dynamics and fail to enable localized semantic awareness of different facial regions. Accordingly, existing techniques do not provide an adequate safety net for advanced deepfake video generation methods.

### SUMMARY

Disclosed herein are systems, devices, and non-transitory computer readable storage media for detecting deepfake images in a video using one or more machine learning models. The one or more machine learning models may be trained to detect deepfake videos by learning temporal (e.g., motion) features associated with real human faces, thus enabling the models to identify features that are uncharacteristic of a real face. The machine learning model(s) may also be trained to focus attention on difficult-to-generate facial regions, such as the eyes and mouth, using region-based masking. Such difficult-to-generate facial regions often include artifacts indicative of a deepfake. Register tokens may also be used during training to provide the machine learning model(s) with extra degrees of freedom to focus on those difficult-to-generate facial regions. Thus, the machine learning models disclosed herein are trained to focus their attention on aspects of videos most likely to contain evidence that the video is fake or real. The one or more machine learning models may then be finetuned for classification using a labeled training dataset including real and deepfake videos.

The deepfake detection techniques disclosed herein may provide several technological advantages over existing deepfake detection models. For instance, existing solutions do not explicitly model dynamics artifacts and lack awareness with respect to semantics of different facial regions. Training a machine learning model to learn temporal dynamics features present in real videos via a temporal reconstruction task according to examples disclosed herein enables the model to better recognize temporal features indicative of fake videos. Additionally, most discriminative features for detection lie in difficult-to-generate facial regions such as the eyes and mouth. Training a machine learning model for deepfake detection via region-specific masking and with the addition of register tokens guides the model's attention to such difficult-to-generate facial regions, thus enabling the model to focus on facial regions most indicative of a “real” or “fake” video. The machine learning models disclosed herein achieve state-of-the-art robustness on ‘in-the-wild’ perturbations that videos experience, as well as improved model interpretability using semantic register tokens modeling.

According to an aspect, a method for detecting deepfake images in a video comprises: receiving time-series image data from the video; inputting the time-series image data into an encoder module of a machine learning model to generate one or more embeddings, wherein the encoder module of the machine learning model has been trained by: obtaining a plurality of training videos; for each training video of the plurality of training videos: obtaining a plurality of masked image patches and a plurality of unmasked image patches; predicting spatial information included in the plurality of masked image patches based on the plurality of unmasked image patches using the machine learning model; predicting temporal information included in the plurality of masked image patches based on the plurality of unmasked image patches using the machine learning model; comparing the predicted spatial information and predicted temporal information to ground truth spatial information and ground truth temporal information; and updating the encoder module of the machine learning model based on the comparison; inputting the one or more embeddings into a classifier module of the machine learning model, wherein the classifier module is trained to generate a classification result classifying the time-series image data as real or fake using the plurality of image embeddings; and outputting the classification result from the classifier classifying the time-series image data from the video as real or fake.

Optionally, the machine learning model has been trained using a plurality of register tokens concatenated to the plurality of unmasked image patches.

Optionally, the ground truth temporal information is obtained by: determining a difference between a first frame captured at a first time included in a training video of the plurality of training videos and a second frame captured at a second time included in the training video.

Optionally, the first frame and the second frame are consecutive frames in the training video.

Optionally, the ground truth temporal information is obtained by: comparing a position of an object in a first frame included in a training video of the plurality of training videos to a position of the object in a second frame included the training video.

Optionally, the ground truth spatial information comprises pixel data from the plurality of masked image patches.

Optionally, each training video depicts a face.

Optionally, predicting the spatial information comprises predicting one or more facial features.

Optionally, predicting the temporal information comprises predicting a movement of one or more facial features.

Optionally, obtaining the plurality of masked image patches comprises masking one or more facial features.

Optionally, the plurality of unmasked image patches comprise one or more facial features other than the one or more facial features included in the plurality of masked image patches.

Optionally, the one or more facial features included in the plurality of unmasked image patches include a mouth and an eye.

Optionally, obtaining the plurality of masked image patches comprises: generating a segmentation map based on the time series of training images depicting the face, wherein the segmentation map defines a plurality of facial regions of the face; assigning a respective subset of image patches to each of the plurality of facial regions such that each facial region is assigned a corresponding subset of image patches; masking the subset of image patches assigned to at least one facial region in each of the time series of training images.

Optionally, the plurality of facial regions comprise: an eye region, a hair region, a nose region, a mouth region, and a skin region.

Optionally, the method comprises masking the subsets of image patches assigned to at least three facial regions of the plurality of facial regions in each of the time series of images included in the training video.

Optionally, the subsets of image patches are non-overlapping.

Optionally, the plurality of facial regions are non-overlapping.

Optionally, masking the subset of image patches assigned to at least one facial region in each of the time series of images included in the time series of training images comprises masking more than 50 percent of the plurality of image patches from the time series of training images.

Optionally, the encoder module of the machine learning model is trained via self-supervised learning.

Optionally, the encoder module of the machine learning model comprises a vision transformer model.

Optionally, the classifier module of the machine learning model is trained via supervised learning using labeled training videos.

Optionally, the classifier module is trained using a binary cross entropy loss objective.

According to an aspect, a system for detecting deepfake images in a video comprises one or more processors, a memory, and one or more programs, wherein the one or more programs are stored in the memory and configured to be executed by the one or more processors, the one or more programs including instructions for: receiving time-series image data from the video; inputting the time-series image data into an encoder module of a machine learning model to generate one or more embeddings, wherein the encoder module of the machine learning model has been trained by: obtaining a plurality of training videos; for each training video of the plurality of training videos: obtaining a plurality of masked image patches and a plurality of unmasked image patches; predicting spatial information included in the plurality of masked image patches based on the plurality of unmasked image patches using the machine learning model; predicting temporal information included in the plurality of masked image patches based on the plurality of unmasked image patches using the machine learning model; comparing the predicted spatial information and predicted temporal information to ground truth spatial information and ground truth temporal information; and updating the encoder module of the machine learning model based on the comparison; inputting the one or more embeddings into a classifier module of the machine learning model, wherein the classifier module is trained to generate a classification result classifying the time-series image data as real or fake using the plurality of image embeddings; and outputting the classification result from the classifier classifying the time-series image data from the video as real or fake.

According to an aspect, a non-transitory computer-readable storage medium stores one or more programs for detecting deepfake images in a video, the one or more programs comprising instructions, which when executed by one or more processors of an electronic device, cause the electronic device to: receive time-series image data from the video; input the time-series image data into an encoder module of a machine learning model to generate one or more embeddings, wherein the encoder module of the machine learning model has been trained by: obtaining a plurality of training videos; for each training video of the plurality of training videos: obtaining a plurality of masked image patches and a plurality of unmasked image patches; predicting spatial information included in the plurality of masked image patches based on the plurality of unmasked image patches using the machine learning model; predicting temporal information included in the plurality of masked image patches based on the plurality of unmasked image patches using the machine learning model; comparing the predicted spatial information and predicted temporal information to ground truth spatial information and ground truth temporal information; and updating the encoder module of the machine learning model based on the comparison; input the one or more embeddings into a classifier module of the machine learning model, wherein the classifier module is trained to generate a classification result classifying the time-series image data as real or fake using the plurality of image embeddings; and output the classification result from the classifier classifying the time-series image data from the video as real or fake.

According to an aspect, a method of training a machine learning model to detect deepfake videos comprises: receiving a plurality of masked image patches and a plurality of unmasked image patches from a training video; predicting spatial information included in the plurality of masked image patches based on the plurality of unmasked image patches using the machine learning model; predicting temporal information included in the plurality of masked image patches based on the plurality of unmasked image patches using the machine learning model; comparing the predicted spatial information and predicted temporal information to ground truth spatial information and ground truth temporal information; and updating the machine learning model based on the comparison.

Optionally, the method includes concatenating a plurality of register tokens to the plurality of unmasked image patches and inputting the plurality of register tokens into the machine learning model.

Optionally, the ground truth temporal information is obtained by: determining a difference between at least a first frame captured at a first time included in the training video and at least a second frame captured at a second time included in the training video.

Optionally, the first frame and the second frame are consecutive frames in the training video.

Optionally, the ground truth temporal information is obtained by: comparing a position of an object in at least a first frame included in the training video to a position of the object in at least a second frame included the training video.

Optionally, the ground truth spatial information comprises pixel data from the plurality of masked image patches.

Optionally, the training video depicts a face.

Optionally, predicting the spatial information comprises predicting one or more facial features.

Optionally, predicting the temporal information comprises predicting a movement of one or more facial features.

Optionally, one or more facial features are masked in the plurality of masked image patches.

Optionally, the plurality of unmasked image patches comprise one or more facial features other than the one or more facial features that are masked in the plurality of masked image patches.

Optionally, the one or more facial features included in the plurality of unmasked image patches include a mouth and an eye.

Optionally, the plurality of masked image patches are obtained by: generating a segmentation map based on the training video, wherein the segmentation map defines a plurality of facial regions of the face; assigning a respective subset of image patches to each of the plurality of facial regions such that each facial region is assigned a corresponding subset of image patches; masking the subset of image patches assigned to at least one facial region in each frame the training video.

Optionally, the plurality of facial regions comprise: an eye region, a hair region, a nose region, a mouth region, and a skin region.

Optionally, the method includes masking the subsets of image patches assigned to at least three facial regions of the plurality of facial regions in each of the time series of images included in the training video.

Optionally, the subsets of image patches are non-overlapping.

Optionally, the plurality of facial regions are non-overlapping.

Optionally, masking the subset of image patches assigned to at least one facial region in each frame of the training video comprises masking more than 50 percent of the plurality of image patches from the training video.

Optionally, the machine learning model is trained via self-supervised learning.

Optionally, the machine learning model comprises a vision transformer model.

Optionally, a classifier module of the machine learning model is trained via supervised learning using labeled training videos.

Optionally, the classifier module is trained using a binary cross entropy loss objective.

According to an aspect, a system for training a machine learning model to detect deepfake videos comprises one or more processors, a memory, and one or more programs, wherein the one or more programs are stored in the memory and configured to be executed by the one or more processors, the one or more programs including instructions for receiving a plurality of masked image patches and a plurality of unmasked image patches from a training video; predicting spatial information included in the plurality of masked image patches based on the plurality of unmasked image patches using the machine learning model; predicting temporal information included in the plurality of masked image patches based on the plurality of unmasked image patches using the machine learning model; comparing the predicted spatial information and predicted temporal information to ground truth spatial information and ground truth temporal information; and updating the machine learning model based on the comparison.

According to an aspect, a non-transitory computer-readable storage medium storing one or more programs for training a machine learning model to detect deepfake videos, the one or more programs comprising instructions, which when executed by one or more processors of an electronic device, cause the electronic device to: receive a plurality of masked image patches and a plurality of unmasked image patches from a training video; predict spatial information included in the plurality of masked image patches based on the plurality of unmasked image patches using the machine learning model; predict temporal information included in the plurality of masked image patches based on the plurality of unmasked image patches using the machine learning model; compare the predicted spatial information and predicted temporal information to ground truth spatial information and ground truth temporal information; and update the machine learning model based on the comparison.

In some embodiments, any one or more of the characteristics of any one or more of the systems, methods, and/or computer-readable storage mediums recited above may be combined, in whole or in part, with one another and/or with any other features or characteristics described elsewhere herein.

### BRIEF DESCRIPTION OF THE FIGURES

The patent or application file contains at least one drawing executed in color. Copies of this patent or patent application publication with color drawing(s) will be provided by the Office upon request and payment of the necessary fee.

A better understanding of the features and advantages of the present disclosure will be obtained by reference to the following detailed description that sets forth illustrative embodiments, in which the principles of the disclosure are utilized, and the accompanying drawings of which:

FIG. 1 illustrates an exemplary method for classifying videos as fake or real, according to some examples.

FIG. 2 illustrates an exemplary method for training a deepfake detection model, according to some examples.

FIG. 3 illustrates an exemplary machine learning model architecture and training method, according to some examples.

FIG. 4 illustrates the temporal difference between consecutive frames for real and deepfake videos, showing the difference for real videos contains more fine-grain details compared to fake videos, according to some examples.

FIG. 5 illustrates input video frames and corresponding attention-masked frames, according to some examples.

FIG. 6 illustrates an exemplary computing device, according to some examples.

### DETAILED DESCRIPTION

Disclosed herein are systems, devices, methods, and non-transitory computer readable storage media for detecting deepfake images in a video. According to some examples, one or more machine learning models may be trained to detect deepfake videos by learning both temporal features (e.g., motion) and spatial features associated with real human faces. During training the one or more machine learning models may be guided to focus attention on difficult-to-generate facial regions, such as the eyes and mouth, using region-based masking. As described above, register tokens may also be used during training to provide the machine learning model(s) with extra degrees of freedom to focus on those difficult-to-generate facial regions.

In some examples, the one or more machine learning models are trained according to a two-stage training process. In a first training stage, the one or more machine learning models are trained via self-supervised learning to learn both temporal features (e.g., motion) and spatial features associated with real human faces. In some examples, during the first training stage, a training video is processed to generate a segmentation map defining a plurality of facial regions (e.g., eyes, nose, mouth, skin, hair, etc.). Subsets of image patches included in the time-series image data from the video may be assigned to respective facial regions of the segmentation map. The image patches assigned to one or more of the facial regions may be masked. The unmasked image patches may be input into an encoder module of a machine learning model. A plurality of register tokens may be input into the encoder module alongside the unmasked image patches to provide the machine learning model additional degrees of freedom to focus on difficult-to-generate regions, as discussed. The encoder module may generate a plurality of embeddings based on the unmasked image patches and a plurality of embeddings based on the register tokens. At least some of the embeddings of the register tokens may be discarded.

The plurality of embeddings generated based on the unmasked image patches and the plurality of masked image patches may be input into multiple decoders during the self-supervised training stage. The decoders may include a spatial decoder and a temporal decoder. The spatial decoder may predict/reconstruct spatial information (e.g., pixel values) included in the plurality of masked image patches based on the plurality of unmasked image patches. The temporal decoder may predict/reconstruct temporal information (e.g., first-order dynamics) included in the plurality of masked image patches based on the plurality of unmasked image patches. The predicted/reconstructed temporal information and spatial information may be compared to ground truth spatial information and ground truth temporal information, and the one or more machine learning models may be updated based on the comparison.

The ground truth temporal information may be obtained by determining a difference between a first frame captured at a first time included in the video and a second frame captured at a second time included in the video. In some examples, the ground truth temporal information is obtained by comparing a position of an object in a first frame included in the video to a position of the object in a second frame included the video. In some examples, the first frame and the second frame are consecutive frames in the training video. In some examples, the ground truth temporal information is obtained by determining a difference between all consecutive frames in the video (e.g., (frame 2−frame 1, frame 4−frame 3, frame 6−frame 5, etc.). In some examples, the ground truth spatial information includes pixel data from the plurality of masked image patches.

In a second training stage, the one or more machine learning models may be finetuned using labeled training data to classify videos as real or fake. During the second training stage, the decoders used during the first self-supervised training stage may be replaced by a classifier module (e.g., a linear classification layer). The classifier module may be trained using a binary cross entropy loss objective. The labeled training data may include real vides of human faces and deepfake videos of human faces. The videos in the labeled training data may be labeled as either real or fake.

After training (e.g., during inference), the one or more machine learning models trained according to the methods disclosed herein can be implemented for robust deepfake video detection. According to some examples, a system receives time-series image data from a video. The video may depict a face, such as a human face. The time-series image data may be input into a machine learning model that has been trained to classify the video as real or fake (e.g., as described above). An encoder module of the machine learning model may generate one or more embeddings representing the time-series image data. The embeddings may capture temporal features (e.g., motion) and spatial features of the time-series image data. The embeddings may be processed by the classifier module to generate a classification output classifying the video as real or fake.

The classification output may be displayed to a user, for instance, via a user interface. In some examples, the classification output may be transmitted to or otherwise sent to a computing system, software engine, etc., configured to execute an action based on the classification output. In some examples, a computing system software engine, etc., may be configured to receive the classification output and automatically (e.g., algorithmically) remove, block the transmission, upload, etc. of, label, or otherwise flag a video classified as a deepfake based on the classification output. In some examples, the output includes an explanation of the classification output, such as an attention map indicating facial regions that contributed to the classification of the video as real or fake.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear from the description below. In addition, the present invention is not described with reference to any particular programming language. It will be appreciated that a variety of programming languages may be used to implement the teachings of the present disclosure as described herein.

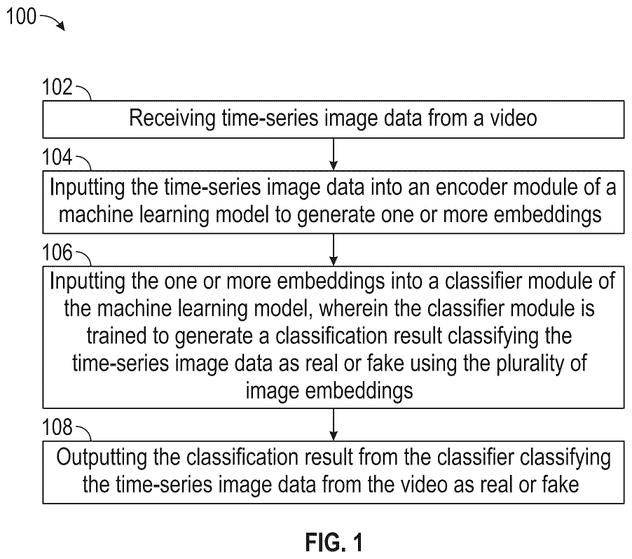

FIG. 1 illustrates aspects of an exemplary process 100 for detecting deepfake images in a video. Process 100 is performed, for example, using one or more electronic devices implementing a software platform. In some examples, process 100 is performed using a client-server system, and the blocks of process 100 are divided up in any manner between the server and a client device. In other examples, the blocks of process 100 are divided up between the server and multiple client devices. Thus, while portions of process 100 may be described herein as being performed by particular devices of a client-server system, it will be appreciated that process 100 is not so limited. In other examples, process 100 is performed using only a client device or only multiple client devices. In process 100, some blocks are, optionally, combined, the order of some blocks is, optionally, changed, and some blocks are, optionally, omitted. In some examples, additional steps may be performed in combination with the process 100. Accordingly, the operations as illustrated (and described in greater detail below) are exemplary by nature and, as such, should not be viewed as limiting.

At block 102, an exemplary system (e.g., one or more electronic devices) receives time-series image data from a video. The video may include a plurality of frames. Each frame may depict at least one human face at a respective point in time. A first frame may depict a human face at a first time, a second frame may depict the human face at a second time, etc.

At block 104, the exemplary system may input the time-series image data from the video into an encoder module of a machine learning model to generate one or more embeddings. The embeddings may be lower dimensional vector representations of the time-series image data that capture rich semantic information about the time-series image data (e.g. particular facial features such as the eyes, nose, mouth, etc., movements of the facial features, etc.), while excluding information that is not relevant to downstream analyses (for instance, the orientation of the image). The embeddings may capture temporal information and spatial information and thus enable analysis of changes in the images included in the time series over time (e.g., movements of facial features across frames of a video) and analysis of particular facial regions. Training the machine learning model to capture both temporal and spatial information enables more accurate downstream deepfake detection.

The machine learning model may include an encoder module. The encoder module may include a vision transformer. In some examples, training the encoder module of the machine learning model includes a self-supervised learning stage. During the self-supervised learning stage, the machine learning model may include an encoder module and a decoder module. During the inferencing stage illustrated in FIG. 1, the decoder module may be replaced with a classifier module. Training the machine learning model, including the encoder module, during the self-supervised learning stage may include obtaining a plurality of training videos, and for each training video of the plurality of training videos, obtaining a plurality of masked image patches and a plurality of unmasked image patches. The training videos may each depict a human face. Obtaining the plurality of masked image patches may include masking one or more facial features. The plurality of unmasked image patches may include one or more facial features other than the one or more facial featured included in the plurality of masked image patches.

In some examples, obtaining the plurality of masked image patches includes generating a segmentation map based on the time series of training images depicting the face. The segmentation map may define a plurality of facial regions of the face. The plurality of facial regions may include an eyes region, a nose region, a mouth region, a hair region, and a skin region. The skin region may be the skin other than the skin included in the eyes region, nose region, hair region, and mouth region. The plurality of facial regions may be non-overlapping. After generating the segmentation map, respective subsets of image patches may be assigned to each of the plurality of facial regions such that each facial region is assigned a corresponding subset of image patches. The subsets of image patches may be non-overlapping. Thus, each subset of image patches may be assigned to only one facial region. In some examples, the subsets of image patches may be overlapping such that a given subset may be assigned to more than one facial region. At least one subset of image patches assigned to at least one facial region may then be masked in each of the time series of training images. For instance, the subset of image patches assigned to the mouth region may be masked in each of the time series of training images. In some examples the subset(s) of image patches assigned to at least three facial regions of the plurality of facial regions in each of the time series of images included in the training video may be masked. For instance, the skin, hair, and nose regions may be masked in each of the time series of images included in the training video.

In some examples, at least 50 percent of the plurality of image patches from the time-series of training images are masked. In some examples, at least 60 percent of the plurality of image patches from the time-series of training images are masked. In some examples, at least 70 percent of the plurality of image patches from the time-series of training images are masked. In some examples, at least 80 percent of the plurality of image patches from the time-series of training images are masked. In some examples, at least 90 percent of the plurality of image patches from the time-series of training images are masked. In some examples, at least 95 percent of the plurality of image patches from the time-series of training images are masked. In some examples, up to 99 percent of the image patches from the time-series of training images are masked.

Training the encoder module may include predicting spatial information included in the plurality of masked image patches based on the plurality of unmasked image patches using the machine learning model. Predicting the spatial information may include predicting one or more facial features. For instance, if the nose region is masked, the machine learning model may be trained to predict the facial features associated with the masked nose region using unmasked images patches associated with different facial regions. Training the encoder module may include predicting temporal information included in the plurality of masked image patches based on the plurality of unmasked image patches using the machine learning model. Predicting the temporal information may include predicting a movement of one or more facial features.

Training the encoder module may include comparing the predicted spatial information and predicted temporal information to ground truth spatial information and ground truth temporal information and updating the encoder module of the machine learning model based on the comparison. The ground truth information may be obtained by determining a difference between a first frame captured at a first time included in a training video of the plurality of training videos and a second frame captured at a second time included in the training video. In some examples, the first frame and the second frame may be consecutive frames. In some examples, the first frame and the second frame may not be consecutive frames. In some examples, the ground truth temporal information is obtained by determining a difference between all consecutive frames in the video (e.g., (frame 2−frame 1, frame 4−frame 3, frame 6−frame 5, etc.). In some examples, the ground truth temporal information is obtained by comparing a position of an object in a first frame included in a training video of the plurality of training videos to a position of the object in a second frame included the training video. In some examples, the ground truth spatial information and/or temporal information includes unmasked pixel data associated with the plurality of masked image patches.

In some examples, the one or more machine learning models, including the encoder module, is trained using a plurality of register tokens, for instance, as described in Timoth'ee Darcet, Maxime Oquab, Julien Mairal, and Piotr Bojanowski Vision Transformers Need Registers. arXiv preprint arXiv:2309.16588 (2023), which is incorporated herein by reference in its entirety. The plurality of register tokens may be concatenated to the plurality of unmasked image patches. The register tokens guide the machine learning model's attention to difficult-to-generate regions without supervision. Difficult-to-generate facial regions, for instance, the eyes and mouth, are artifact-prone and thus guiding the model's attention to these regions enables training of a model that can more accurately detect deepfakes by paying attention to those regions that are more likely to include deepfake indicative artifacts.

At block 106, the exemplary system may input the one or more embeddings into a classifier module of the machine learning model. The classifier module may have been trained to generate a classification result classifying the time-series image data as real or fake using the plurality of image embeddings. The classifier module may be trained during a supervised finetuning stage following the self-supervised training stage discussed above using embeddings generated using the encoder module of the machine learning model. At block 108, the exemplary system may output the classification result from the classifier classifying the time-series image data from the video as real or fake. Additional detail regarding training of both the encoder module and the classifier module is provided below.

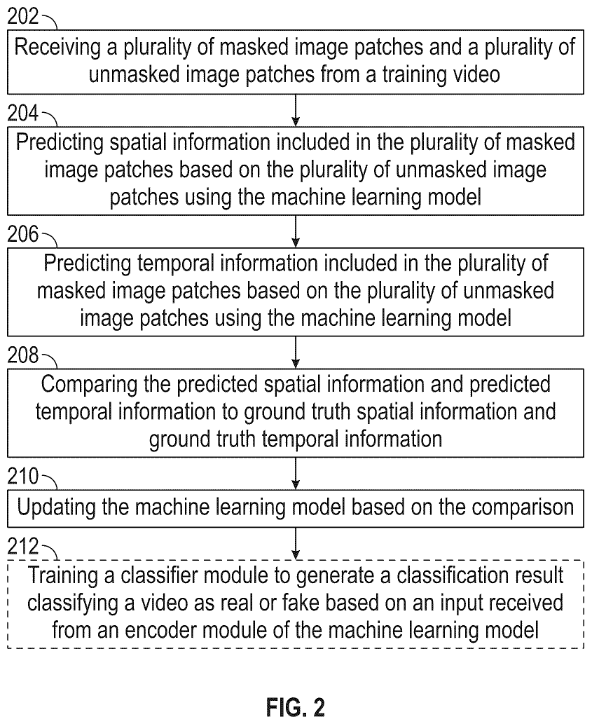

FIG. 2 illustrates aspects of an exemplary process 200 for training a machine learning model. Blocks 202-210 of process 200 may represent a self-supervised learning stage. Block 212 may represent a supervised learning (e.g., finetuning) stage. The machine learning model trained according to process 200 may include an encoder module and one or more decoder modules during the self-supervised learning stage. During the supervised learning stage, the one or more decoder modules may be replaced with a classifier module that may be finetuned to classify videos as real or face. Any or all aspects of process 200 may be used to train the encoder module and/or classifier module of the machine learning model described with reference to process 100 of FIG. 1.

The machine learning model may be trained according to process 200 to learn features that are rich in dynamics information in addition to spatial information. The machine learning model may be trained according to process 200 to focus on semantically rich regions, such as the eyes and mouth, from real videos of faces. The model can thus learn how real videos move with a focus on such semantically rich regions. The training method may include training the machine learning model to reconstruct both spatial information (e.g., pixel values) and temporal information (e.g., first-order dynamics). Moreover, the model's ability to learn features corresponding to particular facial regions may be augmented by using region aware masking of the training input and concatenating register tokens to the input patches. Register tokens boost unsupervised object discovery performance by providing the machine learning model extra degrees of freedom to focus on semantically rich patches in the input without supervision. The register tokens are thus suited for guiding model's attention to difficult-to-generate regions as they contain more information compared to other regions.

Process 200 is performed, for example, using one or more electronic devices implementing a software platform. In some examples, process 200 is performed using a client-server system, and the blocks of process 200 are divided up in any manner between the server and a client device. In other examples, the blocks of process 200 are divided up between the server and multiple client devices. Thus, while portions of process 200 may be described herein as being performed by particular devices of a client-server system, it will be appreciated that process 200 is not so limited. In other examples, process 200 is performed using only a client device or only multiple client devices. In process 200, some blocks are, optionally, combined, the order of some blocks is, optionally, changed, and some blocks are, optionally, omitted. In some examples, additional steps may be performed in combination with the process 200. Accordingly, the operations as illustrated (and described in greater detail below) are exemplary by nature and, as such, should not be viewed as limiting.

At block 202, an exemplary system (e.g., one or more electronic devices) receives a plurality of masked image patches and a plurality of unmasked image patches from a training video. The training video may depict a face (e.g., a human face). In some examples, the exemplary system performing process 200 obtains the plurality of masked image patches and the plurality of unmasked image patches from the training video. The exemplary system may extract a plurality of frames from the training video and generate a segmentation map that defines a plurality of facial regions of the face. The segmentation map may indicate pixels corresponding to facial regions including an eye region, nose region, mouth region, hair region, skin region. The segmentation map may also indicate a background region. This segmentation map may be used to assign a region to each image patch in the training video and selectively mask specific regions for training. The system may assign a respective subset of image patches to each of the plurality of facial regions such that each facial region is assigned a corresponding subset of image patches. For instance, a subset may be assigned to the eye region, a subset may be assigned to the skin region, a subset may be assigned to the mouth region, a subset may be assigned to the hair region, a subset may be assigned to the nose region, and a subset may be assigned to the background region.

The system may mask the subset of image patches assigned to at least one facial region in each frame extracted from the video. In some examples, the system may randomly select three facial regions and mask the subset of image patches assigned to each of the three facial regions in each frame extracted from the video. In some examples, if a predefined masking ratio is exceeded (e.g., 0.90), the system may randomly select image patches and unmask the randomly selected patches. The received plurality of masked image patches and the plurality of unmasked image patches from the training video may be used to train the machine learning model.

At block 204, the exemplary system may predict spatial information included in the plurality of masked image patches based on the plurality of unmasked image patches using the machine learning model. Predicting the spatial information may include predicting one or more facial features. The predicted spatial information may include pixel values for a plurality of pixels included in the plurality of masked image patches. For example, if the skin region is masked and the eye region and mouth region are unmasked, the machine learning model may predict pixel values for the skin region based on the pixel values for the unmasked eye region and/or mouth region. Thus, the machine learning model can be trained to learn associations between spatial characteristics of different facial regions, enabling the model to predict an appearance of one or more regions of the face based on the appearance of one or more other regions of the face.

At block 206, the exemplary system may predict temporal information included in the plurality of masked image patches based on the plurality of unmasked image patches using the machine learning model. Predicting the temporal information may include predicting a movement of one or more facial features. Thus, the machine learning model can be trained to learn associations between movements in different facial regions, for instance, enabling the machine learning model to predict a movement in one or more facial regions based on a movement in one or more other facial regions.

Predicting the spatial information included in the plurality of masked image patches based on the plurality of unmasked image patches at block 206 and predicting the temporal information included in the plurality of masked image patches based on the plurality of unmasked image patches at block 208 may include inputting the plurality of unmasked image patches into an encoder module of the machine learning model to generate a plurality of embeddings and inputting the plurality of embeddings and the plurality of masked image patches into a first decoder module and a second decoder module of the machine learning model to reconstruct the spatial information and temporal information, respectively. The predicted spatial information may include the reconstructed spatial information generated using the decoder and the predicted temporal information may include the reconstructed temporal information generated using the decoder. The predicted spatial information and the predicted temporal information may be compared to ground truth information and the machine learning model may be updated based on a difference between the predicted spatial information and the ground truth spatial information and a difference between the predicted temporal information and the ground truth temporal information, as described below.

At block 208, the exemplary system may compare the predicted spatial information and predicted temporal information to ground truth spatial information and ground truth temporal information. The ground truth temporal information may be obtained by determining a difference between a first frame captured at a first time included in the training video and a second frame captured at a second time included in the training video. The first frame and the second frame may be consecutive frames in the training video. In some examples, the ground truth temporal information is obtained by determining a difference between all consecutive frames in the video (e.g., (frame 2−frame 1, frame 4−frame 3, frame 6−frame 5, etc.). The ground truth temporal information may be obtained by comparing a position of an object in a first frame included in the training video to a position of the object in a second frame included the training video. The ground truth spatial information may include pixel data from the plurality of masked image patches. Comparing the predicted spatial information to ground truth spatial information may include computing a difference between the predicted spatial information and the ground truth spatial information. Comparing the predicted temporal information to ground truth temporal information may include computing a difference between the predicted temporal information and ground truth temporal information. The computed difference for the predicted and ground truth spatial and/or temporal information may be an absolute difference.

At block 210, the exemplary system may update the machine learning model based on the comparison. Updating the machine learning model may include updating the encoder module of the machine learning model based on the comparison. For instance, the machine learning model may be trained to minimize the difference the difference between the predicted and ground truth spatial and/or temporal information. In some examples, an optimization objective used for training is the sum of losses between the predicted spatial information and the ground truth spatial information and between the predicted temporal information and ground truth temporal information.

As noted above, process 200 may include a supervised learning stage during which a classifier module is trained to classify training videos as real or fake. For instance, at block 212, the exemplary system may train a classifier module to generate a classification result classifying a video as real or fake based on an input received from the encoder module trained during blocks 202-210. Prior to block 212, the first and second decoder modules of the machine learning model trained during blocks 202-210 may be replaced by the classifier module. The classifier module may be a linear layer connected to the end of the trained encoder module (e.g., trained according to blocked 202-210). The trained encoder module may be initialized using weights learned during the self-supervised training stage. One or more labeled training videos may be input into the trained encoder to generate a plurality of embeddings. The one or more labeled training videos may be assigned a label (e.g., a binary label) corresponding to “real” or “fake.” The plurality of embeddings generated using the trained encoder module may be input into the classifier module to generate a classification output. Binary cross entropy may be used as the loss objective to train the machine learning model including the classification module to detect deepfake videos.

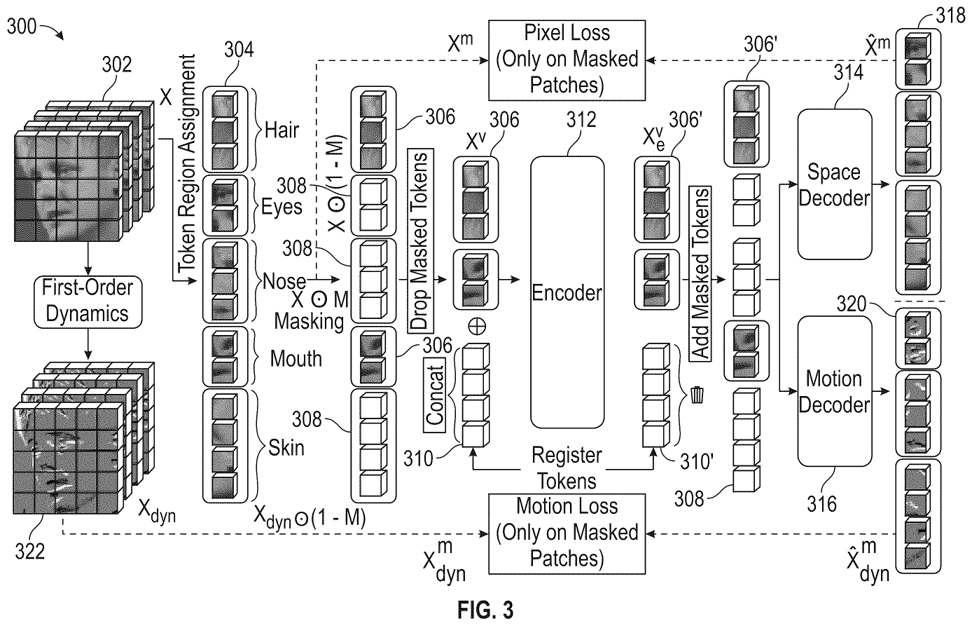

FIG. 3 illustrates a detailed schematic diagram of a process 300 for training a machine learning model. Any or all aspects of process 300 may be performed during the self-supervised learning stage discussed with reference to process 200. Process 300 is performed, for example, using one or more electronic devices implementing a software platform. In some examples, process 300 is performed using a client-server system, and the blocks of process 300 are divided up in any manner between the server and a client device. In other examples, the blocks of process 300 are divided up between the server and multiple client devices. Thus, while portions of process 300 may be described herein as being performed by particular devices of a client-server system, it will be appreciated that process 300 is not so limited. In other examples, process 300 is performed using only a client device or only multiple client devices. In process 300, some blocks are, optionally, combined, the order of some blocks is, optionally, changed, and some blocks are, optionally, omitted. In some examples, additional steps may be performed in combination with the process 300. Accordingly, the operations as illustrated (and described in greater detail below) are exemplary by nature and, as such, should not be viewed as limiting.

An exemplary system performing process 300 may extract a plurality of frames 302 from a video. The video may depict a face (e.g., a human face). The plurality of frames may be processed to generate a segmentation map that segments each frame into a plurality of facial regions and/or background region(s). The segmentation map may include an eye region, a hair region, a nose region, a mouth region, a skin region, and/or a background region. The system may assign a respective subset of image patches 304 to each of the plurality of facial regions such that each facial region is assigned a corresponding subset of image patches. For instance, as shown in FIG. 3, a subset may be assigned to a hair region, a subset may be assigned to an eye region, a subset may be assigned to a nose region, a subset may be assigned to a mouth region, and a subset may be assigned to a skin region. The subsets may be non-overlapping such that each subset of image patches is assigned to only one facial region.

The system performing process 300 may mask at least one subset of image patches assigned to at least one facial region in each frame extracted from the video to generate one or more subsets of unmasked image patches 306 and one or more subsets of masked image patches 308. In some examples, the system may randomly select at least one region and mask the subset of image patches assigned to the at least one facial region in each frame extracted from the video. In some examples, the system randomly selects at least two, at least three, or at least four facial regions and masks the image patches assigned to those facial regions. In some examples, image patches assigned to one or more predefined facial regions are masked. In some examples, if a predefined masking ratio is exceeded (e.g., 0.90), the system may randomly select image patches and unmask the randomly selected patches.

The plurality of unmasked image patches 306 may be input into an encoder module 312 of the machine learning model. In some examples, a plurality of register tokens 310 may be concatenated to the plurality of unmasked image patches 306 and input into the encoder module 312 of the machine learning model. As discussed above, register tokens boost unsupervised object discovery performance by providing the machine learning model extra degrees of freedom to focus on semantically rich patches in the input without supervision. For instance, the register tokens may guide the model's attention to the eyes and mouth such that the model focuses on difficult-to-generate facial regions. In some examples, learnable positional embeddings are included in the input to the encoder module 312 of the machine learning model. In some examples, the input to the encoder module 312 may be projected to encoder dimension d_{enc} via linear layer before being processed by the encoder 312. The encoder module 312 may be a Vision Transformer (ViT) model. The masked image patches 308 may not be input into the encoder module 312 of the machine learning model. The encoder module 312 may process the plurality of unmasked image patches 306 and the plurality of register tokens 310 to generate a plurality of embeddings. The plurality of embeddings may include a plurality of encoded unmasked image patches 306′ and a plurality of encoded register tokens 310′. The plurality of encoded register tokens 310′ may be discarded.

The plurality of encoded unmasked image patches 306′ and the plurality of masked image patches 308 may be input into a first decoder 314 and a second decoder 316. Decoder specific positional embeddings may also be input into the first decoder 314 and the second decoder 316 along with the encoded unmasked image patches 306′ and the plurality of masked image patches 308. The first decoder 314 may be configured to reconstruct spatial information in the plurality of masked image patched 308 based on the encoded unmasked image patches 306′ to generate a first reconstruction output 318. The second decoder 316 may be configured to reconstruct temporal information in the plurality of masked image patched 308 based on the encoded unmasked image patches 306′ to generate a second reconstruction output 320. The first reconstruction output 318 may include predicted spatial information. The predicted spatial information may include one or more facial features. The spatial information may be predicted for the plurality of masked image patches 308 based on the plurality of unmasked image patches 306 (e.g., based on the encoded unmasked image patches 306′). The predicted spatial information may include predicted pixel values of the pixels in the plurality of masked image patches 306. The second reconstruction output 320 may include predicted temporal information. The predicted temporal information may include a predicted movement of one or more facial features. The temporal information may be predicted for the plurality of masked image patches 308 based on the plurality of unmasked image patches 306 (e.g., based on the encoded unmasked image patches 306′). The predicted temporal information may include a predicted movement/motion between at least two frames of the video. For instance, the predicted temporal information may include a reconstructed L₁ difference (e.g., first order dynamics) of two consecutive frames for the masked patches.

The first decoder 314 and the second decoder 316 may be ViT models. The first decoder 314 and the second decoder 316 may have smaller dimensions than the encoder ViT. The dimension size may be reduced by 2, depth may be reduced by 3, and number of heads may be reduced by 2. This reduction in dimensions effectively scales down representation capacity of decoder 314 and 316, respectively, by a factor of 12 as compared to the encoder 312, making the machine-learning model architecture computationally efficient and ensuring that relatively more learning is done by the encoder 312 compared to the decoders 314 and 316. Because both decoders (decoder 314 and decoder 316) are provided the same input, the encoder learns features useful for predicting both spatial and temporal information.

The machine learning model may updated to train the model to minimize the difference (e.g., L₂ difference) between output of the decoders 314 and 316 and the target output of the respective decoders (e.g., ground truth spatial information for decoder 314 and ground truth temporal information for decoder 316). The ground truth temporal information may be obtained by determining a difference between at least two frames included in the video. The two frames may be consecutive frames in the video. The ground truth temporal information may be obtained by comparing a position of an object in a first frame included in a training video of the plurality of training videos to a position of the object in a second frame included the training video. The ground truth temporal information may be obtained by computing an absolute difference between at least two frames in the video. The ground truth spatial information may include pixel data from the plurality of masked image patches. Final reconstruction loss may be obtained as:

$${ℒ}_{rec} = {𝔼}_{x ∈ {𝒟}_{R}} [ {‖ {x}^{m} - {\hat{x}}^{m} ‖}_{F}^{2} + {‖ {x}_{dyn}^{m} - {\hat{x}}_{dyn}^{m} ‖}_{F}^{2} ]$$

where ∥·∥_{F} denotes Frobenius norm.

The systems and methods disclosed herein thus provide technical improvements over existing deepfake detection methods at least by (i) guiding semantic awareness towards difficult-to-generate regions to mimic for deepfakes such as eyes and mouth using region register tokens; and (ii) explicitly learning improved temporal features from real faces via reconstruction of first-order dynamics. The systems and methods disclosed herein thus enable both temporal feature learning and localized semantic awareness. The systems and methods disclosed herein also do not require audio data alongside input video data, thus substantially expanding the amount of training data available and the applicability of the systems and methods disclosed herein to a additional applications.

### Example Implementation & Comparison to Existing Techniques

In this section, an exemplary implementation of the systems and methods disclosed herein supports the following observations: (i) deepfake videos lack fine-grained temporal dynamics present in real videos and (ii) most discriminative features for deepfake detection lies in difficult-to-generate regions such as eyes and mouth.

### Verifying Lack of Fine-Grained Temporal Dynamics in Fake Videos

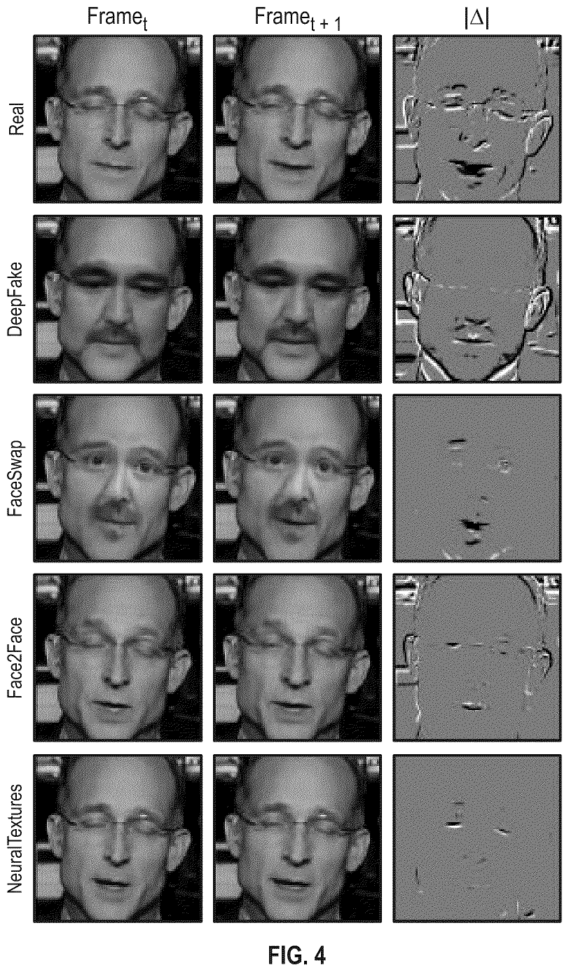

To verify lack of fine-grained temporal dynamics in fake videos as compared to real videos, the average temporal difference was measured between consecutive frames for samples from the FF++ dataset, described in Andreas Rossler, Davide Cozzolino, Luisa Verdoliva, Christian Riess, Justus Thies, and Matthias Nieβner. Faceforensics++: Learning to detect manipulated facial images, Proceedings of the IEEE/CVF international conference on computer vision, pages 1-11, (2019), which is incorporated herein by reference in its entirety, and compared for real vs. fake subsets. After rescaling input to be between 0 and 1, the average difference for the real subset is 2.22e-3 and for the fake subset is 2.16e-3. The lower number for the fake subset shows a lack of variability between consecutive frames, indicating lack of details in first-order dynamics. In FIG. 4, two consecutive frames and their L₁ difference are visualized for a real video and all four methods of the FF++ dataset: DeepFakes, FaceSwap, Face2Face and NeuralTextures. A real video was selected and fakes generated from that video were used for direct and fair comparison. As shown in FIG. 4, the temporal difference image for the real frames contains much more fine-grained information as compared to the fake samples. In whole-face swapping methods (DeepFakes and FaceSwap) this may be due to the same single target face image being used to swap face in all frames from a source video. Reenactment methods (Face2Face and NeuralTextures), meanwhile, try to keep the identity the same as the source face while changing expressions and mouth movement. This dual objective leads to less variability in certain regions and thus results in lower variance across frames.

### Performance Evaluation of Region-Based Masking Strategy

To evaluate the masking process employed in the systems and methods disclosed herein, three autoencoders were trained with various masking strategies: (i) random masking, which is used to pretrain most conventional autoencoders; (ii) “fasking”, introduced by Zhixi Cai, Shreya Ghosh, Kalin Stefanov, Abhinav Dhall, Jianfei Cai, Hamid Rezatofighi, Reza Haffari, and Munawar Hayat, Marlin: Masked autoencoder for facial video representation learning, Proceedings of the IEEE/CVF conference on computer vision and pattern recognition, pages 1493-1504, (2023), which is incorporated herein by reference in its entirety, and which makes the representation more aware of facial attributes; (iii) the improved region based masking according to examples disclosed herein. Then, during inference, one region is masked at a time to determine how faithful the reconstruction is based on L₂ distance. Results are shown in Table 1, below. The eyes and mouth regions have larger L₂ distance compared to other regions, indicating higher “difficulty” in reconstruction. The exemplary implementation of the deepfake detection method disclosed herein achieves lowest L₂loss, demonstrating the effectiveness of the pretraining framework disclosed herein.

TABLE 1
L₂ reconstruction error per face region for three masking
strategies. Eyes and mouth have highest error indicating
generative models' inability to reconstruct them accurately
and thus making them more susceptible to forgery artifacts.

| Masking | Eyes | Nose | Mouth | Hair | Skin |
|---|---|---|---|---|---|
| Random | 2.13e−3 | 8.9e−4 | 2.7e−3 | 9.3e−4 | 7.3e−4 |
| MARLIN | 2e−3 | 1.1e−3 | 3.4e−3 | 7.7e−4 | 7.8e−4 |
| Ours | 1.4e−3 | 8.1e−4 | 2.2e−3 | 7.4e−4 | 5.6e−4 |

### Two-Stage Training

The training method used for the exemplary implementation disclosed herein included two stages. The first stage involved learning dynamics (temporal information, as described throughout) and semantic aware features (spatial information, as described throughout) via self-supervised learning based on MAE and register tokens. Register tokens enable the model's attention to be guided towards difficult-to-generate regions (eyes and mouth), while reconstruction of dynamics enhances the model's capability to learn temporal information beyond architecture's default ability. In second stage, the backbone (e.g., the encoder module) from first stage was finetuned as a classifier for the real vs deepfake task (e.g., a linear layer was connected to the encoder module and the model was finetuned as a classifier).

### Preprocessing

The LRS3 dataset, described in Triantafyllos Afouras, Joon Son Chung, and Andrew Zisserman, Lrs3-ted: a large-scale dataset for visual speech recognition, arXiv preprint arXiv:1809.00496, (2018), which is incorporated herein by reference in its entirety, was used for stage 1 self-supervised learning. It contains around 10000 videos with corresponding audios and transcripts. The audio component and transcripts were discarded as the pretraining framework only required visual component. Faces were extracted from visual frames in videos. During the exemplary implementation, faces were extracted from visual frames in videos using off-the-shelf model FaceXZoo, described in Jun Wang, Yinglu Liu, Yibo Hu, Hailin Shi, and Tao Mei, Facex-zoo: A pytorch toolbox for face recognition, Proceedings of the 29th ACM international conference on Multimedia, pages 3779-3782, (2021), which is incorporated herein by reference in its entirety. However, it should be understood that other machine learning models could be used to extract the faces. Subsequently, extracted frames were parsed using the same model to obtain a segmentation map indicating pixels corresponding to five facial regions; eyes, nose, mouth, hair, skin as well as background. This segmentation map was used to assign a region to each patch in the input video and selectively mask specific regions during our pretraining. The masking strategy employed during the exemplary implementation is described in next section.

### Training Stage 1: Self-Supervised Representation Learning

During the self-supervised learning stage, a machine learning model was trained to learn features that are rich in dynamics information (e.g., temporal/motion information) in addition to spatial information. The machine learning model was trained to focus on eyes and mouth using real videos of faces. The model learned how real videos move with a focus on semantically rich regions (e.g., the eyes and mouth). An approximation of first-order dynamics of input video was added to a vanilla Masked Autoencoder (MAE) pixel values reconstruction objective. Moreover, the model's ability to learn features corresponding to facial regions was augmented by using region aware masking for the input and by concatenating register tokens to the input patches. Register tokens have shown to boost unsupervised object discovery performance via providing machine learning models extra degrees of freedom to focus on semantically rich patches in the input without any supervision. This makes them useful for guiding a model's attention to difficult-to-generate regions as those regions contain more information compared to other regions.

During the pretraining stage, a large corpus of real video clips was used to build a dataset D_{R}. A sample from D_{R} is a video x∈R^{T×C×H×W} with number of frames T, number of channels C, height H and width W. To obtain x, 2T consecutive frames were sampled from a given video v, maintaining every other frame, thus

$$x = {\{ {v}_{2 t} \}}_{t = 0}^{T - 1} .$$

The L₁ temporal difference was used between nearby frames as a proxy for first-order dynamics,

$${x}_{dyn} = {\{ {v}_{2 t + 1} - {v}_{2 t} \}}_{t = 0}^{T - 1} .$$

A number of input tokens was obtained by tokenizing x with non-overlapping 2×16×16 patches in T, H and W dimensions making the number of input tokens to be

$$n = \frac{T}{2} \cdot \frac{H}{16} \cdot \frac{W}{16}$$

and token dimension to be d=2·16·16·C making final shape of an input x to be n×d. For number of tokens to be masked, a masking ratio was defined as α∈[0,1], which makes number of masked tokens m=α·n.

The masking strategy included defining three random regions prior to masking, and masking patch tokens in the entire video corresponding to those regions. Then, if the masking ratio was exceeded, one or more patch tokens were unmasked. The final mask was defined as M. After masking, visible tokens were denoted as x^{v} and masked tokens as x^{m}. The number of visible tokens and masked tokens were (1−α)·n and α·n respectively. The masked tokens for x_{dyn} were denoted as x^{m}_{dyn}.

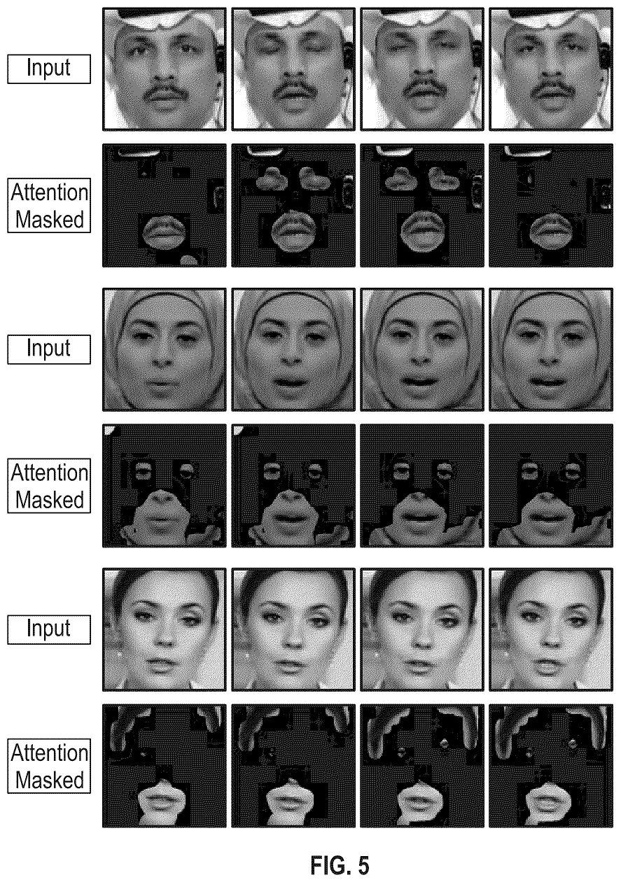

A Vision Transformer (ViT) was used as the encoder in the exemplary implementation. Input tokens were projected to encoder dimension d_{enc} via linear layer before being processed by the encoder. Two steps were performed before input x^{v} is passed to the encoder: (i) learnable positional embeddings were added p∈R^{nd}^{_{enc}} to it: x^{v}=x^{v}+p and (ii) k randomly initialized learnable register tokens were concatenated r∈R^{k×d}^{_{enc}} to it: x^{v}=x^{v} ⊕r. The addition of register tokens guides model's attention to eyes and mouth as visualized in FIG. 5, thus enabling focus on difficult-to-generate regions. FIG. 5 shows attention-rollout from register token to patch tokens after stage 1. As shown in FIG. 5, attention is more guided towards image patches where movement is prominent as seen by increased attention on eyes while a blink happens in the top example. This makes final input shape to be [(1−α)·n+k]×d_{enc}. This input is passed through to the encoder to obtain embeddings x^{v}ₑ. Before passing these embeddings for further processing, extra register tokens were dropped making the shape (1−α)·n×d_{enc}.

ViTs with smaller dimensions than the encoder ViT were used for the decoders. The dimension size was reduced by 2, depth was reduced by 3 and the number of heads was reduced by 2. This effectively scales down representation capacity of the decoders by a factor of 12 as compared to the encoder, making the architecture computationally efficient and ensuring that most of the learning was done by the encoder. Mask tokens are concatenated to encoded visible tokens, x^{v}ₑ, to indicate which tokens were masked by M and a decoder specific positional embedding was added before passing them to both decoders. Two decoders were used: space decoder (e.g., the decoder trained to predict spatial information described with reference to FIGS. 1-3) and motion decoder (e.g., the decoder trained to predict temporal information described with reference to FIGS. 1-3). The space decoder was trained to reconstruct masked patches' pixel values and the motion decoder was trained reconstruct the L₁ difference of two consecutive frames for the masked patches. The output of the space and motion decoders was denoted as x\hat{ }^{m} and x\hat{ }^{m}_{dyn} respectively. Since both decoders share the same input, the encoder is forced to learn features necessary for predicting both spatial and dynamics information. The L₂ difference was minimized between output of the decoders, x\hat{ }^{m} and x\hat{ }^{m}_{dyn}, and their corresponding targets, x^{m} and x^{m}_{dyn}, as our loss. The final reconstruction loss is given by:

$${ℒ}_{rec} = {𝔼}_{x ∈ {𝒟}_{R}} [ {‖ {x}^{m} - {\hat{x}}^{m} ‖}_{F}^{2} + {‖ {x}_{dyn}^{m} - {\hat{x}}_{dyn}^{m} ‖}_{F}^{2} ]$$

where ∥·∥_{F} denotes Frobenius norm.

The following configurations and hyperparameters were used during pretraining stage for the exemplary implementation: For input x, T=16 was used as number of frames to select. For each frame, the frame was resized to 224×224 making H=W=224 and C=3 for RGB channels. No augmentations were applied during pretraining. Masking ratio α was set to 0.9 for all experiments making the overall framework computationally efficient as the encoder only sees 10% of the tokens. ViT-Base described in Alexey Dosovitskiy, An image is worth 16×16 words: Transformersfor image recognition at scale, arXiv preprint arXiv:2010.11929, (2020), which is incorporated herein by reference, was used as the encoder. Encoder dimension, depth and number of heads were 768, 12 and 12 respectively. Input tokens were projected to the encoder dimension before processing. The decoder dimension, depth and number of heads were 384, 4 and 6 respectively. The encoder output was projected to decoder dimension using linear layer before processing. The Adam optimizer described in Diederik P Kingma Adam: A method for stochastic optimization, arXiv preprint arXiv:1412.6980, (2014), which is incorporated herein by reference in its entirety, was used with learning rate 1.5e-4 and betas (0.9,0.95). Cosine annealing was used with warm restarts scheduler Ilya Loshchilov and Frank Hutter, Sgdr: Stochastic gradient descent with warm restarts, arXiv preprint arXiv:1608.03983, (2016), which is incorporated herein by reference in its entirety, with minimum learning rate 1e-6 with 10000 steps for restarts. Learning rate was used warmup for 1000 steps.

### Training Stage 2: Deepfake Detection

The supervised training for classification performed in stage 2 was done using the FF++ dataset. The FF++ dataset contains 1000 real videos and 4000 fake videos generated from real videos using following methods: (1) FaceSwap (FS), (2) DeepFakes (DF), (3) Face2Face (F²F) and (4) NeuralTextures (NT). A c23 compressed version of FF++ was used. To test cross-generalization to other datasets and methods, the exemplary implementation utilized CelebDF (CDF) described in Yuezun Li, Xin Yang, Pu Sun, Honggang Qi, and Siwei Lyu, Celeb-df:A largescale challenging dataset for deepfake forensics, Proceedings of the IEEE/CVF conference on computer vision and pattern recognition, pages 3207-3216, (2020), Deepfake Detection Challenge (DFDC) described in Brian Dolhansky, Joanna Bitton, Ben Pflaum, Jikuo Lu, Russ Howes, Menglin Wang, and Cristian Canton Ferrer, The deepfake detection challenge (dfdc) dataset, arXiv preprint arXiv:2006.07397, (2020), Deepfakedetection (DFD) described in Deepfakedetection, https://research.google/blog/contributing-data-to-deepfake-detection-research, and FaceShifter (FSh) [27] Lingzhi Li, Jianmin Bao, Hao Yang, Dong Chen, and Fang Wen, Advancing high fidelity identity swapping for forgery detection, Proceedings of the IEEE/CVF conference on computer vision and pattern recognition, pages 5074-5083, (2020) datasets, each of which is incorporated herein by reference in its entirety. Area under the receiver operating characteristic curve (AUC) was used as an evaluation metric. Video level score was calculated as an average of non-overlapping clip scores from a video.

### Pretraining Interpretability Analysis

The goal of the self-supervised training stage (stage 1) is to learn features which are temporal-dynamics aware and focused on difficult-to-generate regions. To verify the success of stage 1, an attention map was visualized using attention rollout from one of the register tokens to patch tokens for a video. Random videos were selected from FF++ dataset, which is disjoint from pretraining dataset for this analysis. After obtaining the attention map, the attention map was binarized by setting values greater than average value to be 1 and setting the remaining values to 0. The results obtained by multiplying this binarized attention map with the video are shown in FIG. 5. As shown in FIG. 5, (1) attention is focused toward semantically rich face regions such as eyes and mouth and (2) attention is more guided towards image patches where movement is prominent as seen by increased attention on eyes while a blink happens in the top example. The illustration shown in FIG. 5 may be generated using an attention rollout method and may visualize how a token of a Vision Transformer focuses on other tokens.

TABLE 2
AUC scores (%) on CelebDF-v2 (CDF), DeepFake Detection
Challenge (DFDC), FaceShifter (FSh), and Deepfakedetection
(DFD), after training on FF++. Best results are
in bold, second best results are underlined.

| Method | CDF | DFDC | FSh | DFD |
|---|---|---|---|---|
| Xception [38] | 73.7 | 70.9 | 72.0 | 81.6 |
| CNN-aug [48] | 75.6 | 72.1 | 65.7 | 64.6 |
| Patch-based [7] | 69.6 | 65.6 | 57.8 | — |
| Face X-ray [28] | 79.5 | 65.5 | 92.8 | 76.6 |
| CNN-GRU [39] | 69.8 | 68.9 | 80.8 | — |
| Multi-task [34] | 75.7 | 68.1 | 66.0 | — |
| DSP-FWA [29] | 69.5 | 67.3 | 65.5 | 74.0 |
| Two-branch [32] | 76.7 | — | — | — |
| LipForensics [19] | 82.4 | 73.5 | 97.1 | — |
| FTCN [55] | 86.9 | 74.0 | 98.8 | — |
| RealForensics [18] | 86.9 | 75.9 | 99.7 | — |
| RAD (Ours) | 82.4 | 75.1 | 99.4 | 88.4 |

### Baseline Selection

Self-supervised learning, especially visual-only self-supervised learning for deepfake detection has been under explored. RealForensics, described in Alexandros Haliassos, Rodrigo Mira, Stavros Petridis, and Maja Pantic, Leveraging real talking faces via self-supervision for robust forgery detection, Proceedings of the IEEE/CVF Conference on Computer Vision and Pattern Recognition, pages 14950-14962, (2022), which is incorporated herein by reference in its entirety, was used as the primary baseline in addition to other commonly referred methods in the literature. Below several differences are highlighted between RealForensics and the framework disclosed herein (used for this exemplary implementation): (1) RealForensics uses Channel-Separated Convolutional Network (CSN), described in Du Tran, Heng Wang, Lorenzo Torresani, and Matt Feiszli, Video classification with channel-separated convolutional networks, Proceedings of the IEEE/CVF international conference on computer vision, pages 5552-5561, 2019, which is incorporated herein by reference in its entirety, as its backbone which is already optimized for video classification, while the techniques used in this exemplary implementation use an unmodified ViT-Base architecture; (2) RealForensics requires paired audio with the visual frames during pretraining, while the techniques used in this exemplary implementation does not require audio; (3) in addition to FF++, RealForensics also uses their pretraining dataset, LRW, described in Joon Son Chung and Andrew Zisserman, Lip reading in the wild, Computer Vision-ACCV 2016: 13th Asian Conference on Computer Vision, Taipei, Taiwan, Nov. 20-24, (2016), Revised Selected Papers, Part II 13, pages 87-103. Springer, (2017), which is incorporated herein by reference in its entirety, as an auxiliary dataset for deepfake detection training, while the techniques used in this exemplary implementation limit the deepfake training dataset to FF++ only to decouple the effect of the framework from the dataset used; (4) for the deepfake detection stage, RealForensics utilizes student-teacher training in multi-task fashion, while the techniques used in this exemplary implementation finetune the backbone from the self-supervised training stage.

### Cross-Dataset Generalization

It is desirable for a deepfake detector to generalize to newer deepfake generation methods as such methods get better in realism and contain less forgery artifacts, making the detection more difficult. To verify the ability of the model used in this exemplary implementation in such a scenario, CDF, DFD, FaceShifter and DFDC datasets were used. All of these datasets were released after initial FF++ release and have deepfakes generated from newer methods. Results of this experiment are in Table 2, above.

### Robustness to Common Perturbations

In addition to good cross-dataset generalization, it is desirable for a ready-to-deploy deepfake detector to be robust against common corruptions videos experience. A procedure outlined in Alexandros Haliassos, Rodrigo Mira, Stavros Petridis, and Maja Pantic, Leveraging real talking faces via self-supervision for robust forgery detection, Proceedings of the IEEE/CVF Conference on Computer Vision and Pattern Recognition, pages 14950-14962, (2022), was applied to measure the robustness of the model used in this exemplary implementation against unseen perturbations applied to videos. The set of considered perturbations were taken from Liming Jiang, Ren Li, Wayne Wu, Chen Qian, and Chen Change Loy, Deeperforensics-1.0: A large-scale dataset for real-world face forgery detection, Proceedings of the IEEE/CVF conference on computer vision and pattern recognition, pages 2889-2898, (2020), which is incorporated herein by reference in its entirety, and includes the following: adding Gaussian noise and blur, changing contrast and saturation, random block-wise occlusions and compression. Each perturbation had 5 levels of intensity and each was applied to a video before passing through the detector. Training and test datasets were from FF++ with no overlap in augmentations used in training with perturbations. The average AUC across intensity levels for all the perturbations are shown in Table 3, below. On the model utilized in this exemplary implementation outperformed all of the baselines. The model utilized in this exemplary implementation is more robust to blur and compression as compared to other methods. The highest performance was observed drop for Gaussian noise perturbation, but the model utilized in this exemplary implementation remains more robust to Gaussian noise when compared to a significant portion of the baselines.

TABLE 3
Average AUC score (%) across 5 intensity levels for each perturbation
described in section 5.4, as well as average score across perturbations
for each method. Best scores are shown in bold.

| Method | Clean | Saturation | Contrast | Block | Noise | Blur | Compress | Avg |
|---|---|---|---|---|---|---|---|---|
| Xception [38] | 99.8 | 99.3 | 98.6 | 99.7 | 53.8 | 60.2 | 62.1 | 79.0 |
| CNN-aug [48] | 99.8 | 99.3 | 99.1 | 95.2 | 54.7 | 76.5 | 72.5 | 82.9 |
| Patch-based [7] | 99.9 | 84.3 | 74.2 | 99.2 | 50.0 | 54.4 | 53.4 | 69.2 |
| Face X-ray [28] | 99.8 | 97.6 | 88.5 | 99.1 | 49.8 | 63.8 | 55.2 | 75.7 |
| CNN-GRU [39] | 99.9 | 99.0 | 98.8 | 97.9 | 47.9 | 71.5 | 74.5 | 81.6 |
| LipForensics [19] | 99.9 | 99.9 | 99.6 | 87.4 | 73.8 | 96.1 | 95.6 | 92.1 |
| FTCN [55] | 99.4 | 99.4 | 96.7 | 97.1 | 53.1 | 95.8 | 86.4 | 88.1 |
| RealForensics [18] | 99.8 | 99.8 | 99.6 | 98.9 | 79.7 | 95.3 | 97.6 | 95.1 |
| RAD (Ours) | 99.7 | 99.7 | 99.6 | 99.1 | 76.2 | 98.4 | 99.3 | 95.4 |

Ablation was performed to assess each component's contribution to final performance. Results show that learning region and dynamics aware representations boosts the base model's ability to generalize to datasets with unseen generation methods, FaceShifter (FSh) and DFDC. A videoMAE model was trained with random tube masking as described in Zhan Tong, Yibing Song, Jue Wang, and Limin Wang, Videomae: Masked autoencoders are data-efficient learners for self-supervised video pre-training, Advances in neural information processing systems, 35:10078-10093, (2022), which is incorporated herein by reference in its entirety. This architecture does not contain register tokens or motion decoder. Region aware masking and register tokens, then a motion decoder, were sequentially added. Results are shown in Table 4, below.

TABLE 4
Framework ablation. AUC scores (%) on FaceShifter
(FSh) and DFDC after training on FF++.

| Method | FSh | DFDC |
|---|---|---|
| videoMAE [44] | 95.34 | 69.79 |
| ↑ + region aware | 98.34 | 71.35 |
| masking/tokens | | |
| ↑ + motion decoder | 99.36 | 75.10 |

Register tokens were used for the encoder, which gave the model extra degrees of freedom to guide its attention towards difficult-to-generate regions. Observe were a 3% and 1.56% AUC boost compared to random masking in videoMAE [44] on FaceShifter and DFDC respectively. A motion decoder was added to the architecture enhancing its ability to capture first-order dynamics information to be utilized by deepfake detection training in stage 2. This led to further 1.02% and 3.75% increase in AUC score on FaceShifter and DFDC.

### Exemplary Computing Device

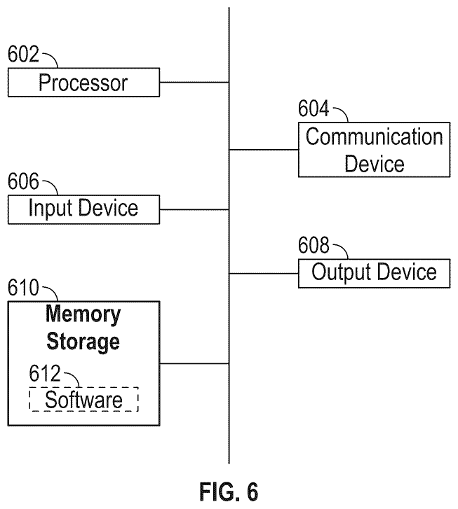

FIG. 6 depicts an exemplary computing device 600, that may be utilized in accordance with one or more examples of the disclosure. Device 600 can be a host computer connected to a network. Device 600 can be a client computer or a server. As shown in FIG. 6, device 600 can be any suitable type of microprocessor-based device, such as a personal computer, workstation, server, or handheld computing device (portable electronic device) such as a phone or tablet. The device can include, for example, one or more of processors 602, input device 606, output device 608, storage 610, and communication device 604. Input device 606 and output device 608 can generally correspond to those described above and can either be connectable or integrated with the computer.

Input device 606 can be any suitable device that provides input, such as a touch screen, keyboard or keypad, mouse, or voice-recognition device. Output device 608 can be any suitable device that provides output, such as a touch screen, haptics device, or speaker.

Storage 610 can be any suitable device that provides storage, such as an electrical, magnetic, or optical memory, including a RAM, cache, hard drive, or removable storage disk. Communication device 604 can include any suitable device capable of transmitting and receiving signals over a network, such as a network interface chip or device. The components of the computer can be connected in any suitable manner, such as via a physical bus or wirelessly.

Software 612, which can be stored in storage 610 and executed by processor 602, can include, for example, the programming that embodies the functionality of the present disclosure (e.g., as embodied in the devices as described above).

Software 612 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 610, that can contain or store programming for use by or in connection with an instruction execution system, apparatus, or device.

Software 612 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Device 600 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 600 can implement any operating system suitable for operating on the network. Software 612 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

### CLAUSES

1. A method for detecting deepfake images in a video, the method comprising:
receiving time-series image data from the video;
inputting the time-series image data into an encoder module of a machine learning model to generate one or more embeddings, wherein the encoder module of the machine learning model has been trained by:
   obtaining a plurality of training videos;
   for each training video of the plurality of training videos:
      obtaining a plurality of masked image patches and a plurality of unmasked image patches;
      predicting spatial information included in the plurality of masked image patches based on the plurality of unmasked image patches using the machine learning model;
      predicting temporal information included in the plurality of masked image patches based on the plurality of unmasked image patches using the machine learning model;
      comparing the predicted spatial information and predicted temporal information to ground truth spatial information and ground truth temporal information; and
      updating the encoder module of the machine learning model based on the comparison;
inputting the one or more embeddings into a classifier module of the machine learning model, wherein the classifier module is trained to generate a classification result classifying the time-series image data as real or fake using the plurality of image embeddings; and
outputting the classification result from the classifier classifying the time-series image data from the video as real or fake.

2. The method of clause 1, wherein the machine learning model has been trained using a plurality of register tokens concatenated to the plurality of unmasked image patches.

3. The method any one clauses 1-2, wherein the ground truth temporal information is obtained by: determining a difference between a first frame captured at a first time included in a training video of the plurality of training videos and a second frame captured at a second time included in the training video.

4. The method of clause 3, wherein the first frame and the second frame are consecutive frames in the training video.

5. The method of any one of clauses 1-4, wherein the ground truth temporal information is obtained by: comparing a position of an object in a first frame included in a training video of the plurality of training videos to a position of the object in a second frame included the training video.

6. The method of any one of clauses 1-5, wherein the ground truth spatial information comprises pixel data from the plurality of masked image patches.

7. The method of any one of clauses 1-6, wherein each training video depicts a face.

8. The method of any one of clauses 1-7, wherein predicting the spatial information comprises predicting one or more facial features.

9. The method of any one of clauses 1-8, wherein predicting the temporal information comprises predicting a movement of one or more facial features.

10. The method of any one of clauses 1-9, wherein obtaining the plurality of masked image patches comprises masking one or more facial features.

11. The method of clause 10, wherein the plurality of unmasked image patches comprise one or more facial features other than the one or more facial features included in the plurality of masked image patches.

12. The method of clause 11, wherein the one or more facial features included in the plurality of unmasked image patches include a mouth and an eye.

13. The method of any one of clauses 7-12, wherein obtaining the plurality of masked image patches comprises:
generating a segmentation map based on the time series of training images depicting the face, wherein the segmentation map defines a plurality of facial regions of the face;
assigning a respective subset of image patches to each of the plurality of facial regions such that each facial region is assigned a corresponding subset of image patches;
masking the subset of image patches assigned to at least one facial region in each of the time series of training images.

14. The method of clause 13, wherein the plurality of facial regions comprise: an eye region, a hair region, a nose region, a mouth region, and a skin region.

15. The method of any one of clauses 13-14, comprising masking the subsets of image patches assigned to at least three facial regions of the plurality of facial regions in each of the time series of images included in the training video.

16. The method of any one of clauses 13-15, wherein the subsets of image patches are non-overlapping.

17. The method of any one of clauses 13-16, wherein the plurality of facial regions are non-overlapping.

18. The method of any one of clauses 13-17, wherein masking the subset of image patches assigned to at least one facial region in each of the time series of images included in the time series of training images comprises masking more than 50 percent of the plurality of image patches from the time series of training images.

19. The method of any one of clauses 1-18, wherein the encoder module of the machine learning model is trained via self-supervised learning.

20. The method of any one of clauses 1-19, wherein the encoder module of the machine learning model comprises a vision transformer model.

21. The method of any one of clauses 1-20, wherein the classifier module of the machine learning model is trained via supervised learning using labeled training videos.

22. The method of clause 21, wherein the classifier module is trained using a binary cross entropy loss objective.

23. A system for detecting deepfake images in a video, the system comprising one or more processors, a memory, and one or more programs, wherein the one or more programs are stored in the memory and configured to be executed by the one or more processors, the one or more programs including instructions for:
receiving time-series image data from the video;
inputting the time-series image data into an encoder module of a machine learning model to generate one or more embeddings, wherein the encoder module of the machine learning model has been trained by:
   obtaining a plurality of training videos;
   for each training video of the plurality of training videos:
      obtaining a plurality of masked image patches and a plurality of unmasked image patches;
      predicting spatial information included in the plurality of masked image patches based on the plurality of unmasked image patches using the machine learning model;
      predicting temporal information included in the plurality of masked image patches based on the plurality of unmasked image patches using the machine learning model;
      comparing the predicted spatial information and predicted temporal information to ground truth spatial information and ground truth temporal information; and
      updating the encoder module of the machine learning model based on the comparison;
   inputting the one or more embeddings into a classifier module of the machine learning model, wherein the classifier module is trained to generate a classification result classifying the time-series image data as real or fake using the plurality of image embeddings; and
   outputting the classification result from the classifier classifying the time-series image data from the video as real or fake.

24. A non-transitory computer-readable storage medium storing one or more programs for detecting deepfake images in a video, the one or more programs comprising instructions, which when executed by one or more processors of an electronic device, cause the electronic device to:
receive time-series image data from the video;
input the time-series image data into an encoder module of a machine learning model to generate one or more embeddings, wherein the encoder module of the machine learning model has been trained by:
   obtaining a plurality of training videos;
   for each training video of the plurality of training videos:
      obtaining a plurality of masked image patches and a plurality of unmasked image patches;
      predicting spatial information included in the plurality of masked image patches based on the plurality of unmasked image patches using the machine learning model;
      predicting temporal information included in the plurality of masked image patches based on the plurality of unmasked image patches using the machine learning model;
      comparing the predicted spatial information and predicted temporal information to ground truth spatial information and ground truth temporal information; and
      updating the encoder module of the machine learning model based on the comparison;
input the one or more embeddings into a classifier module of the machine learning model, wherein the classifier module is trained to generate a classification result classifying the time-series image data as real or fake using the plurality of image embeddings; and
output the classification result from the classifier classifying the time-series image data from the video as real or fake.

25. A method of training a machine learning model to detect deepfake videos, the method comprising:
receiving a plurality of masked image patches and a plurality of unmasked image patches from a training video;
predicting spatial information included in the plurality of masked image patches based on the plurality of unmasked image patches using the machine learning model;
predicting temporal information included in the plurality of masked image patches based on the plurality of unmasked image patches using the machine learning model;
comparing the predicted spatial information and predicted temporal information to ground truth spatial information and ground truth temporal information; and
   updating the machine learning model based on the comparison.

26. The method of clause 25, comprising concatenating a plurality of register tokens to the plurality of unmasked image patches and inputting the plurality of register tokens into the machine learning model.

27. The method of any one of clauses 25-26, wherein the ground truth temporal information is obtained by: determining a difference between at least a first frame captured at a first time included in the training video and at least a second frame captured at a second time included in the training video.

28. The method of clause 27, wherein the first frame and the second frame are consecutive frames in the training video.

29. The method of any one of clauses 25-28, wherein the ground truth temporal information is obtained by: comparing a position of an object in at least a first frame included in the training video to a position of the object in at least a second frame included the training video.

30. The method of any one of clauses 25-29, wherein the ground truth spatial information comprises pixel data from the plurality of masked image patches.

31. The method of any one of clauses 25-30, wherein the training video depicts a face.

32. The method of any one of clauses 25-31, wherein predicting the spatial information comprises predicting one or more facial features.

33. The method of any one of clauses 25-32, wherein predicting the temporal information comprises predicting a movement of one or more facial features.

34. The method of any one of clauses 25-33, wherein one or more facial features are masked in the plurality of masked image patches.

35. The method of clause 34, wherein the plurality of unmasked image patches comprise one or more facial features other than the one or more facial features that are masked in the plurality of masked image patches.

36. The method of clause 35, wherein the one or more facial features included in the plurality of unmasked image patches include a mouth and an eye.

37. The method of any one of clauses 31-36, wherein the plurality of masked image patches are obtained by:
generating a segmentation map based on the training video, wherein the segmentation map defines a plurality of facial regions of the face;
assigning a respective subset of image patches to each of the plurality of facial regions such that each facial region is assigned a corresponding subset of image patches;
masking the subset of image patches assigned to at least one facial region in each frame the training video.

38. The method of clause 37, wherein the plurality of facial regions comprise: an eye region, a hair region, a nose region, a mouth region, and a skin region.

39. The method of any one of clauses 37-38, comprising masking the subsets of image patches assigned to at least three facial regions of the plurality of facial regions in each of the time series of images included in the training video.

40. The method of any one of clauses 37-39, wherein the subsets of image patches are non-overlapping.

41. The method of any one of clauses 37-40, wherein the plurality of facial regions are non-overlapping.

42. The method of any one of clauses 37-41, wherein masking the subset of image patches assigned to at least one facial region in each frame of the training video comprises masking more than 50 percent of the plurality of image patches from the training video

43. The method of any one of clauses 25-42, the machine learning model is trained via self-supervised learning.

44. The method of any one of clauses 25-43, wherein the machine learning model comprises a vision transformer model.

45. The method of any one of clauses 25-44, wherein a classifier module of the machine learning model is trained via supervised learning using labeled training videos.

46. The method of clause 45, wherein the classifier module is trained using a binary cross entropy loss objective.

47. A system for training a machine learning model to detect deepfake videos, the system comprising one or more processors, a memory, and one or more programs, wherein the one or more programs are stored in the memory and configured to be executed by the one or more processors, the one or more programs including instructions for
receiving a plurality of masked image patches and a plurality of unmasked image patches from a training video;
predicting spatial information included in the plurality of masked image patches based on the plurality of unmasked image patches using the machine learning model;
predicting temporal information included in the plurality of masked image patches based on the plurality of unmasked image patches using the machine learning model;
comparing the predicted spatial information and predicted temporal information to ground truth spatial information and ground truth temporal information; and
updating the machine learning model based on the comparison.

48. A non-transitory computer-readable storage medium storing one or more programs for training a machine learning model to detect deepfake videos, the one or more programs comprising instructions, which when executed by one or more processors of an electronic device, cause the electronic device to:
receive a plurality of masked image patches and a plurality of unmasked image patches from a training video;
predict spatial information included in the plurality of masked image patches based on the plurality of unmasked image patches using the machine learning model;
predict temporal information included in the plurality of masked image patches based on the plurality of unmasked image patches using the machine learning model;
compare the predicted spatial information and predicted temporal information to ground truth spatial information and ground truth temporal information; and
update the machine learning model based on the comparison.

1. A method for detecting deepfake images in a video, the method comprising:
receiving time-series image data from the video;
inputting the time-series image data into an encoder module of a machine learning model to generate one or more embeddings, wherein the encoder module of the machine learning model has been trained by:
obtaining a plurality of training videos;
for each training video of the plurality of training videos:
obtaining a plurality of masked image patches and a plurality of unmasked image patches;
predicting spatial information included in the plurality of masked image patches based on the plurality of unmasked image patches using the machine learning model;
predicting temporal information included in the plurality of masked image patches based on the plurality of unmasked image patches using the machine learning model;
comparing the predicted spatial information and predicted temporal information to ground truth spatial information and ground truth temporal information; and
updating the encoder module of the machine learning model based on the comparison;
inputting the one or more embeddings into a classifier module of the machine learning model, wherein the classifier module is trained to generate a classification result classifying the time-series image data as real or fake using the plurality of image embeddings; and
outputting the classification result from the classifier classifying the time-series image data from the video as real or fake.

2. The method of claim 1, wherein the machine learning model has been trained using a plurality of register tokens concatenated to the plurality of unmasked image patches.

3. The method of claim 1, wherein the ground truth temporal information is obtained by: determining a difference between a first frame captured at a first time included in a training video of the plurality of training videos and a second frame captured at a second time included in the training video.

4. The method of claim 3, wherein the first frame and the second frame are consecutive frames in the training video.

5. The method of claim 1, wherein the ground truth temporal information is obtained by: comparing a position of an object in a first frame included in a training video of the plurality of training videos to a position of the object in a second frame included the training video.

6. The method of claim 1, wherein the ground truth spatial information comprises pixel data from the plurality of masked image patches.

7. The method of claim 1, wherein each training video depicts a face.

8. The method of claim 1, wherein predicting the spatial information comprises predicting one or more facial features.

9. The method of claim 1, wherein predicting the temporal information comprises predicting a movement of one or more facial features.

10. The method of claim 1, wherein obtaining the plurality of masked image patches comprises masking one or more facial features.

11. The method of claim 10, wherein the plurality of unmasked image patches comprise one or more facial features other than the one or more facial features included in the plurality of masked image patches.

12. The method of claim 11, wherein the one or more facial features included in the plurality of unmasked image patches include a mouth and an eye.

13. The method of claim 7, wherein obtaining the plurality of masked image patches comprises:
generating a segmentation map based on the time series of training images depicting the face, wherein the segmentation map defines a plurality of facial regions of the face;
assigning a respective subset of image patches to each of the plurality of facial regions such that each facial region is assigned a corresponding subset of image patches;
masking the subset of image patches assigned to at least one facial region in each of the time series of training images.

14. The method of claim 13, wherein the plurality of facial regions comprise: an eye region, a hair region, a nose region, a mouth region, and a skin region.

15. The method of claim 13, comprising masking the subsets of image patches assigned to at least three facial regions of the plurality of facial regions in each of the time series of images included in the training video.

16. The method of claim 13, wherein the subsets of image patches are non-overlapping.

17. The method of claim 13, wherein the plurality of facial regions are non-overlapping.

18. The method of claim 13, wherein masking the subset of image patches assigned to at least one facial region in each of the time series of images included in the time series of training images comprises masking more than 50 percent of the plurality of image patches from the time series of training images.

19. A system for detecting deepfake images in a video, the system comprising one or more processors, a memory, and one or more programs, wherein the one or more programs are stored in the memory and configured to be executed by the one or more processors, the one or more programs including instructions for:
receiving time-series image data from the video;
inputting the time-series image data into an encoder module of a machine learning model to generate one or more embeddings, wherein the encoder module of the machine learning model has been trained by:
obtaining a plurality of training videos;
for each training video of the plurality of training videos:
obtaining a plurality of masked image patches and a plurality of unmasked image patches;
predicting spatial information included in the plurality of masked image patches based on the plurality of unmasked image patches using the machine learning model;
predicting temporal information included in the plurality of masked image patches based on the plurality of unmasked image patches using the machine learning model;
comparing the predicted spatial information and predicted temporal information to ground truth spatial information and ground truth temporal information; and
updating the encoder module of the machine learning model based on the comparison;
inputting the one or more embeddings into a classifier module of the machine learning model, wherein the classifier module is trained to generate a classification result classifying the time-series image data as real or fake using the plurality of image embeddings; and
outputting the classification result from the classifier classifying the time-series image data from the video as real or fake.

20. A non-transitory computer-readable storage medium storing one or more programs for detecting deepfake images in a video, the one or more programs comprising instructions, which when executed by one or more processors of an electronic device, cause the electronic device to:
receive time-series image data from the video;
input the time-series image data into an encoder module of a machine learning model to generate one or more embeddings, wherein the encoder module of the machine learning model has been trained by:
obtaining a plurality of training videos;
for each training video of the plurality of training videos:
obtaining a plurality of masked image patches and a plurality of unmasked image patches;
predicting spatial information included in the plurality of masked image patches based on the plurality of unmasked image patches using the machine learning model;
predicting temporal information included in the plurality of masked image patches based on the plurality of unmasked image patches using the machine learning model;
comparing the predicted spatial information and predicted temporal information to ground truth spatial information and ground truth temporal information; and
updating the encoder module of the machine learning model based on the comparison;
input the one or more embeddings into a classifier module of the machine learning model, wherein the classifier module is trained to generate a classification result classifying the time-series image data as real or fake using the plurality of image embeddings; and
output the classification result from the classifier classifying the time-series image data from the video as real or fake.
